(19) United States
(12) Patent Application Publication
(10) Pub. No.: US 2018/0092419 A1
(43) Pub. Date: Apr. 5, 2018

(54) HELMET HAVING AN ACCESSORY MOUNTED THEREON

(71) Applicants: Paul J. Banducci, Traverse City, MI (US); Terrance Hand, Andover (GB); Alan Hudson, Andover Hampshire (GB)

(72) Inventors: Paul J. Banducci, Traverse City, MI (US); Terrance Hand, Andover (GB); Alan Hudson, Andover Hampshire (GB)

(21) Appl. No.: 15/722,495

(22) Filed: Oct. 2, 2017

Related U.S. Application Data
(60) Provisional application No. 62/403,729, filed on Oct. 4, 2016.

(51) Int. Cl. A42B 3/04; A42B 3/22; A42B 3/30; A42B 3/28; A42B 3/10; A42B 3/08

(52) U.S. Cl. CPC A42B 3/0406; A42B 3/221; A42B 3/30; G02B 23/125; A42B 3/10; A42B 3/08; A42B 3/28

(57) ABSTRACT

A helmet, the helmet is constructed with top/side mounted picatinny rails on either side of the helmet, wherein the picatinny rails hold a cradle for securing accessories on the helmet. The accessories are capable of rapid deployment and retraction.

This application is a utility application from U.S. provisional patent application Ser. No. 62/403,729, filed Oct. 4, 2016 from which priority is claimed.

### BACKGROUND OF THE INVENTION

This invention deals with a helmet, said helmet being constructed with top/side mounted picatinny rails on either side of the helmet, to secure accessories on the helmet, that allow rapid deployment and retraction of the accessories.

Helmets, typically those helmets which are used in combat and riot situations and the like, provide attachments to the helmet, such as night vision goggles. These goggles are traditionally mounted on the forefront of the helmet. It has been determined that this particular mounting of the goggles cause neck and spine pain after extended wear because of the increased weight hanging off of the front of the helmet.

The helmets that are conventionally sold today that the inventors are aware of, use bolts to fasten the optics to the front of the helmet and this mode of fastening only allows the user to move the goggles up and down from in front of the face.

It would be useful if the user had the capability of moving the goggles to alternative positions, such as, for example, the top or back of the helmet, to distribute the weight of the accessory, especially during periods of non-use. However, with conventional helmets, the user would need to have the goggles remain in position once moved. It would also be useful if the attachment of the goggles to the helmet provided a fast and easy holding and release mechanism.

### THE INVENTION

Thus, what is disclosed and claimed herein is a mounting assembly on a helmet for holding accessories. The mounting assembly comprises a cradle for mounting accessories. The cradle is slidably mounted on dual cables, each cable having two ends. Each cable is mounted on a rail of a spaced-apart dual rail picatinny rail system. Each dual cable is fixedly attached at each end to a picatinny rail. The spaced-apart dual rails are rigidly fixed together.

In another embodiment, there is a mounting system on a helmet for holding accessories. The mounting system comprises a helmet having a front, a back, a top and opposite sides. There is a dual rail picatinny rail system rigidly mounted on the helmet, from front to back.

There is a first arm having a near end and a distal end. The first arm is rotatably attached near the front of the helmet at the near end. The first arm has a second arm which has a near end and a distal end and the second arm is rotatably attached to the distal end of the first arm at a near end of the second arm. The second arm is angled to a rail of the dual rail of the picatinny rail, wherein the distal end of the second arm is slidably attached to a rail of the dual rail of the picatinny rail system.

In yet another embodiment, there is, in combination, a mounting system, and a helmet.

Still another embodiment is the combination set forth just Supra wherein there is, in addition, a visor for the helmet, wherein the visor is removable, a communication device and speakers for the helmet, adjustable night vision goggles for the helmet, mounted on the picatinny rail, a retention system for the helmet, a liner for the helmet, and an air ventilation system for the helmet.

### BRIEF DESCRIPTION OF THE DRAWINGS

FIG. 1 is a full top view of a cradle of this invention.

FIG. 2 is a full end view of a cradle of FIG. 1.

FIG. 3 is a top view in perspective of a helmet having a mounting system of this invention arranged on the top thereof.

FIG. 4 is a full end view of FIG. 1.

FIG. 5 is a full end view of a cradle of this invention showing a light mounted thereon.

### DETAILED DESCRIPTION OF THIS INVENTION

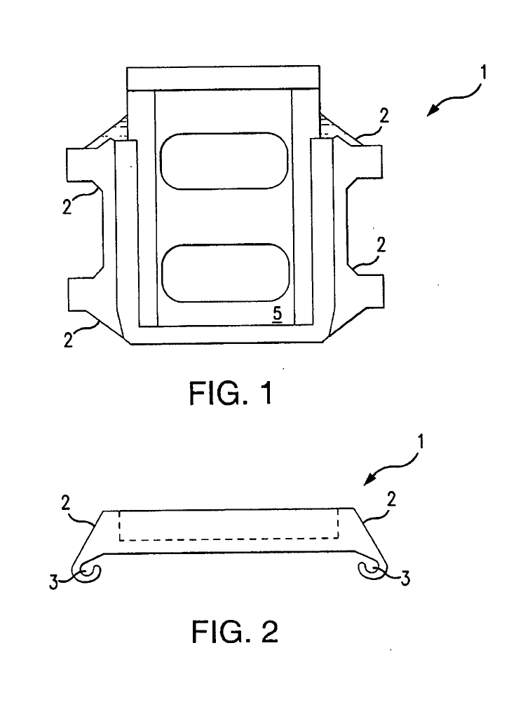

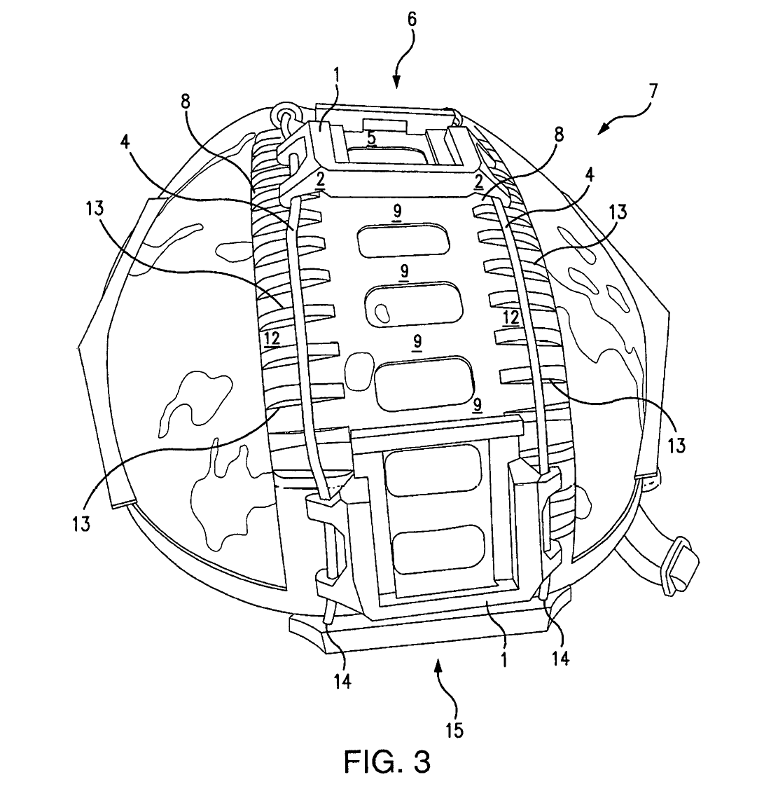

Turning now to FIG. 1, there is shown a full top view of a cradle 1 that is useful in this invention. The cradle 1 is typically manufactured from plastics, aluminum, carbon or other high strength material. It is configured flat with pendent legs 2 (also shown in FIG. 2) in which there are openings 3 through which the cables 4 (shown in FIG. 3) are carried.

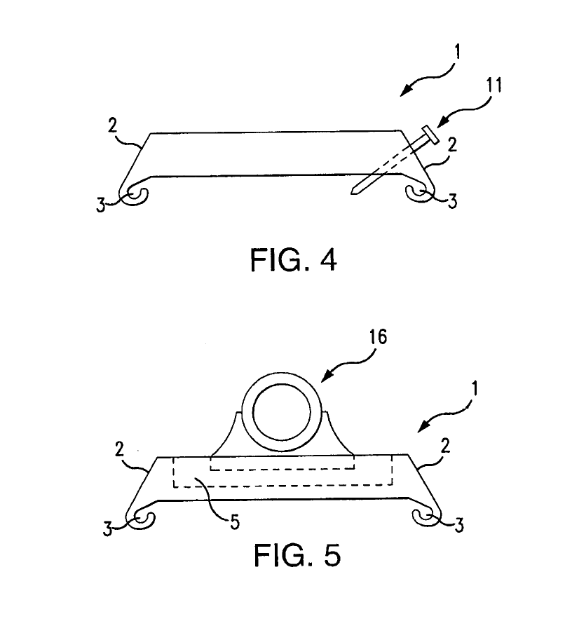

The area 5 is configured to allow the mounting of accessories, such as night vision optics, lights and goggles. The friction provided by the cables 4 against the plastic of the cradle 1 is sufficient to allow for the cradle 1 to be moved along the cables 4 and to keep the cradle 1 in place. In addition, the legs 3 of the cradle 1 are designed such that they will fit into the cross-grooves 13 in the top of the picatinny rails 8. It is contemplated within the scope of this invention to provide a mechanism 11 to lock the cradle 1 in place (See FIG. 4). As can be noted, the cradle 1 can travel the entire distance of the cables 4 such that any accessories mounted on the cradle 1 can be moved from front 15 to back 6 and back to front of the helmet 7 or any point in-between. (Shown in FIG. 3) Two cradles 1 are shown to illustrate the possible positions of the cradle 1 on the front 15 and on the back 6 of the helmet 7. FIG. 5 is a full end view of a cradle 1 of this invention showing a light 16 mounted thereon for illustration purposes.

FIG. 2 is a full end view to show the openings 3 and it should be noted that for this example, there are four legs 2 with openings 3.

Turning now to FIG. 3, there is shown a view in perspective, the helmet 7 from the front 15. It can be observed that there are picatinny rails 8, spaced-apart, and rigidly attached to each other by cross ties 9. In addition, the tops 12 of the rails 8 are scored, or cross-grooved 13. All of the ends 14 of the cables 4 are securely attached to the picatinny rails 8 or to the helmet 7.

The invention contemplates additional accessories for the helmet, which are not part of this invention. Such accessories include a visor for said helmet, wherein the visor is removable, a communication device and speakers for said helmet, adjustable night vision goggles for said helmet, a retention system for said helmet, a liner for said helmet, and an air ventilation system for said helmet. All such accessories are part of the accessories that are in the public domain and well-known to those skilled in the art.

The inventors are not aware of any other similar systems and assemblies for handling accessories on helmets.

What is claimed is:

1. A mounting assembly for use on a helmet, said mounting assembly comprising
a. a cradle for mounting accessories;
b. said cradle being slidably mounted on dual cables, each said cable having two ends, each said cable being mounted on a rail of a spaced-apart dual rail picatinny rail system; each dual cable being fixedly attached at each end to a said picatinny rail or said helmet, said spaced-apart dual rails being rigidly fixed together.

2. A mounting system on a helmet for holding accessories, said mounting system comprising:
i. a spaced-apart dual rail picatinny rail system said spaced-apart dual rails being rigidly fixed together, said rail system rigidly mounted on a helmet, on said top, from front to back;
ii. said picatinny rail system having a slidable mount thereon for holding said accessories, said mount slidable on cables that are mounted on said rails of said picatinny rail, from front to back.

3. A mounting system on a helmet for holding accessories, said mounting system comprising:
i. a helmet having a front, a back, a top and opposite sides;
ii. a dual rail picatinny rail system rigidly mounted on said helmet, from front to back;
iii. a first arm having a near end and a distal end, said first arm being rotatably attached near said front of said helmet at the near end;
iv. said first arm having a second arm having a near end and a distal end and said second arm being rotatably attached to said distal end of said first arm at a near end of said second arm, said second arm being angled to a rail of said dual rail of said picatinny rail, wherein said distal end of said second arm is slidably attached to a cradle for mounting accessories.

4. In combination, a mounting system as claimed in claim 3 and a helmet.

5. The combination as claimed in claim 4 wherein there is, in addition, a visor for said helmet, wherein the visor is removable, a communication device and speakers for said helmet, adjustable night vision goggles for said helmet mounted on said picatinny rail, a retention system for said helmet, a liner for said helmet, and an air ventilation system for said helmet.
